(19) United States
(12) Patent Application Publication
(10) Pub. No.: US 2022/0234238 A1
(43) Pub. Date: Jul. 28, 2022

(54) CUTTING DEVICE AND HOLDER

(71) Applicant: BROTHER KOGYO KABUSHIKI KAISHA, Nagoya (JP)

(72) Inventors: Norikazu KONDO, Okazaki (JP); Hiroki MORI, Nagoya (JP); Yasuhito SHIKAMA, Niwa (JP)

(21) Appl. No.: 17/583,533

(22) Filed: Jan. 25, 2022

(30) Foreign Application Priority Data
Jan. 28, 2021 (JP) 2021-012271

(51) Int. Cl. B26D 7/26

(52) U.S. Cl. CPC B26D 7/2621; B26D 2007/2685; B26D 2007/2657

(57) ABSTRACT

A cutting device that includes a placement member and a carriage. An object to be cut is placed on the placement member. The carriage is configured to move in a first direction and a second direction. The carriage includes a mounting portion, a movement mechanism, and a first spring. A holder that holds a cutting blade that cuts the object to be cut is mounted by the mounting portion. The movement mechanism is configured to move the mounting portion in a third direction and a fourth direction. The first spring is configured to apply a pressure to the mounting portion in the third direction, in accordance with a driving state of the movement mechanism. The holder includes a second spring configured to apply a pressure to the cutting blade in the third direction.

### CROSS-REFERENCE TO RELATED APPLICATIONS

This application claims priority to Japanese Patent Application No. 2021-012271, filed Jan. 28, 2021. The disclosure of the foregoing application is incorporated herein by reference in its entirety.

### BACKGROUND

The present disclosure relates to a cutting device that cuts an object to be cut using a cutting blade, and to a holder that holds the cutting blade.

A cutting device is known that cuts a pattern from an object to be cut by moving the object to be cut and a cutting blade relative to each other. The cutting device includes a carriage capable of moving in the left-right direction with respect to the object to be cut. A cutter holder, an up-down drive mechanism, and a compression coil spring are provided on the carriage. When cutting the object to be cut using the cutting device, the cutter holder is moved downward by the up-down drive mechanism, and a blade tip of a cutter held by the cutter holder comes into contact with the object to be cut. As a result of the cutter holder moving further downward, the compression coil spring becomes compressed. Due to an urging force according to the compression of the compression coil spring, the cutter maintains a cutter pressure with which the object to be cut is pressed.

### SUMMARY

A cutter pressure required when cutting an object to be cut differs, depending on the type of the object to be cut. However, in a cutting device, it is only possible to obtain the cutter pressure as an upper limit of the constant cutter pressure corresponding to characteristics of a compression coil spring. There is a case in which the cutting device cannot appropriately cut the object to be cut, as a result of not being able to apply, to the cutter, the cutter pressure greater than the cutter pressure corresponding to the characteristics of the compression coil spring.

An object of the present disclosure is to provide a cutting device capable of appropriately cutting an object to be cut and a holder that holds a cutting blade.

Various embodiments herein provide a cutting device that includes a placement member and a carriage. An object to be cut is placed on the placement member. The carriage is configured to move in a first direction and a second direction relative to the object to be cut placed on the placement member. The second direction is opposite to the first direction. The carriage includes a mounting portion, a movement mechanism, and a first spring. A holder that holds a cutting blade that cuts the object to be cut is mounted by the mounting portion. The movement mechanism is configured to move the mounting portion in a third direction causing the mounting portion to move closer to the object to be cut placed on the placement member, and a fourth direction causing the mounting portion to move away from the object to be cut placed on the placement member. The third direction and the fourth direction intersect the first direction and the second direction. The first spring is configured to apply a pressure to the mounting portion in the third direction, in accordance with a driving state of the movement mechanism. The holder includes a second spring configured to apply a pressure to the cutting blade in the third direction.

According to the above embodiments, the holder that is detachably mounted to the mounting portion includes the second spring, in comparison to a case in which the holder does not include the second spring, the cutting device can increase the pressure (a cutter pressure) applied to the cutting blade via the mounting portion when cutting the object to be cut. Thus, even when a large cutter pressure is required when cutting the object to be cut, the second spring can apply the appropriate cutter pressure to the cutting blade and can appropriately cut the object to be cut.

Various embodiments also provide a holder that is mountable on a mounting portion of a cutting device. The holder includes a placement member and a carriage. An object to be cut is placed on the placement member. The carriage is configured to move in a first direction and a second direction relative to the object to be cut placed on the placement member. The second direction is opposite to the first direction. The carriage includes the mounting portion, a movement mechanism, and a first spring. The movement mechanism is configured to move the mounting portion in a third direction causing the mounting portion to move closer to the object to be cut placed on the placement member, and a fourth direction causing the mounting portion to move away from the object to be cut placed on the placement member. The third direction and the fourth direction intersect the first direction and the second direction. The first spring is configured to apply a pressure to the mounting portion in the third direction, in accordance with the movement of the mounting portion by the movement mechanism. The holder includes a cutting blade, a support body, a holding body, and a second spring. The cutting blade is configured to cut the object to be cut. The support body is configured to support the cutting blade. The holding body is configured to support the support body to be movable in a fifth direction and a sixth direction opposite to the fifth direction. The holding body is held by the mounting portion. The second spring is configured to urge the support body in the fifth direction with respect to the holding body.

According to the above embodiments, as the holder includes the second spring, in comparison to a case in which the holder does not include the second spring, it is possible to increase the pressure (the cutter pressure) applied to the cutting blade via the mounting portion when cutting the object to be cut. Thus, even when a large cutter pressure is required when cutting the object to be cut, the second spring can apply the appropriate cutter pressure to the cutting blade and can appropriately cut the object to be cut.

### BRIEF DESCRIPTION OF THE DRAWINGS

Embodiments of the disclosure will be described below in detail with reference to the accompanying drawings in which:

FIG. 1 is a perspective view of a cutting device;

FIG. 2 is a perspective view of a carriage in a state in which a holder is mounted thereto;

FIG. 3 is a perspective view of the carriage in a state in which the holder is removed;

FIG. 4 is a front view of the carriage and the holder in a stand-by position;

FIG. 5 is a front view of the carriage and the holder that have moved downward from the stand-by position;

FIG. 6 is a perspective view of the holder;

FIG. 7 is an exploded perspective view of the holder;

FIG. 8 is a cross-sectional view as seen in the direction of arrows along a line A-A shown in FIG. 6; and

FIG. 9 is a perspective view of a support body, a cutting body, an intermediate body, and a second spring.

### DETAILED DESCRIPTION

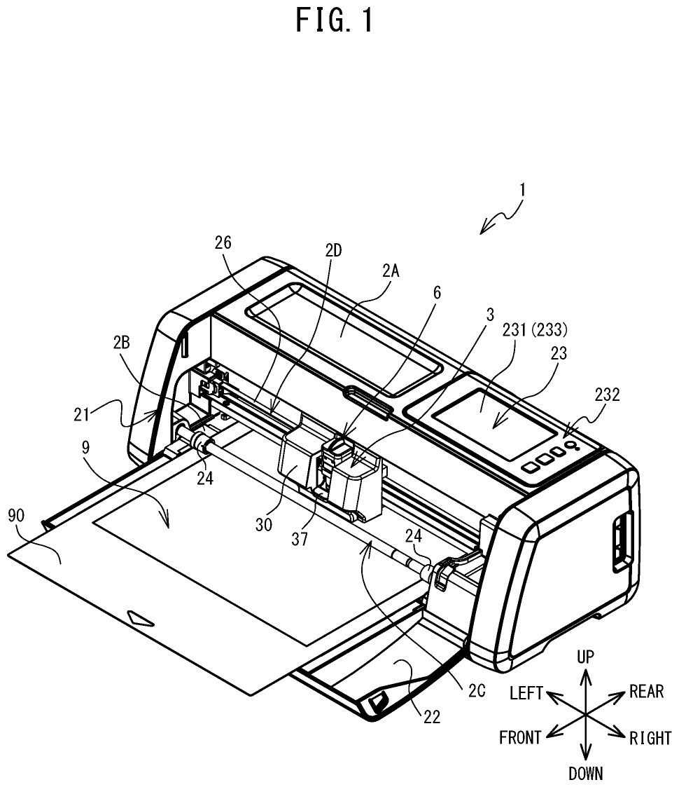

Embodiments embodying a cutting device 1 and a holder 6 according to the present disclosure will be described in order with reference to the drawings. The drawings to be referenced are used to illustrate the technical features that can be adopted in the present disclosure, and the described configurations and the like of the devices are not intended to be limited thereto, but are merely explanatory examples. The lower left side, the upper right side, the lower right side, the upper left side, the upper side, and the lower side in FIG. 1 are the front side, the rear side, the right side, the left side, the upper side, and the lower side, respectively, of the cutting device 1 and the holder 6.

Overview of Cutting Device 1

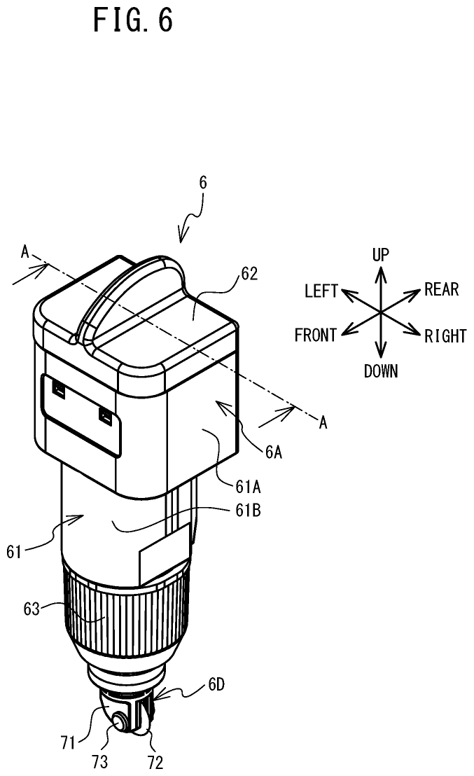

An overview of the cutting device 1 will be described with reference to FIG. 1. The cutting device 1 cut an object to be cut 9 held by a holding portion 90, using a cutting blade 72 (refer to FIG. 6) held by the holder 6. The cutting device 1 is provided with a main body cover 2A, a platen 2B, a carriage 3, a conveyance mechanism 2C, a movement mechanism 2D, and the like.

An opening portion 21, a cover 22, and an operating portion 23 are provided on the main body cover 2A. The opening portion 21 is provided in a front surface portion of the main body cover 2A. The cover 22 is rotatably supported on the main body cover 2A. In FIG. 1, the cover 22 is open, and the opening portion 21 is in an open state. Hereinafter, various configurations are explained on the basis of the state in which the cover 22 is open.

The operating portion 23 is provided with a liquid crystal display (LCD) 231, a plurality of operating switches 232, and a touch panel 233. An image including various items, such as commands, illustrations, setting values, and messages is displayed on the LCD 231. The touch panel 233 is provided on the surface of the LCD 231. A user performs a pressing operation on the touch panel 233, using either a finger or a stylus pen. In the cutting device 1, which of the items has been selected is recognized in accordance with a pressed position detected by the touch panel 233. The user uses the operating switches 232 and the touch panel 233 to select a pattern displayed on the LCD 231, set various parameters, perform an input operation, and the like.

The conveyance mechanism 2C is provided with a driven roller 24 and a drive roller (not shown in the drawings). The driven roller 24 is rotatably supported inside the main body cover 2A. The drive roller faces the driven roller 24 from below, and rotates in accordance with the driving of a Y-axis motor (not shown in the drawings). The conveyance mechanism 2C clamps, between the driven roller 24 and the drive roller, left and right end portions of the rectangular-shaped holding portion 90. The holding portion 90 holds the object to be cut 9. The conveyance mechanism 2C conveys the holding portion 90 in the front-rear direction (also referred to as a “Y direction” and a “sub-scanning direction”), as a result of the drive roller rotating in a state in which the holding portion 90 holds the object to be cut 9. In other words, the conveyance mechanism 2C conveys the object to be cut 9 held by the holding portion 90 in the front-rear direction.

The platen 2B is provided inside the main body cover 2A, and further to the rear than the drive roller. The platen 2B is a plate-shaped member that extends in the left-right direction. The length of the platen 2B in the left-right direction is greater than the width of the holding portion 90 and the object to be cut 9. The holding portion 90 that is conveyed to the rear by the conveyance mechanism 2C is placed on a portion of the upper surface of the platen 2B excluding portions at both ends in the left-right direction. The object to be cut 9 held by the holding portion 90 is placed on the platen 2B via the holding portion 90.

The holder 6 is mounted to the carriage 3. The carriage 3 and the holder 6 will be described in more detail later. The carriage 3 is moved in the left-right direction (hereinafter also referred to as an “X direction” and a “main scanning direction”) by the movement mechanism 2D. The movement mechanism 2D is provided with a guide rail 26, an X-axis motor (not shown in the drawings), and the like. The guide rail 26 is fixed inside the main body cover 2A and extends in the left-right direction. The carriage 3 is supported by the guide rail 26 such that the carriage 3 can move in the X direction along the guide rail 26. The rotational movement of the X-axis motor is converted into motion in the X direction, and this motion is transmitted to the carriage 3. When the X-axis motor is driven forward or in reverse, the carriage 3 is moved in the leftward direction or the rightward direction. In this way, the carriage 3 moves in the left-right direction relative to the object to be cut 9 placed on the platen 2B via the holding portion 90.

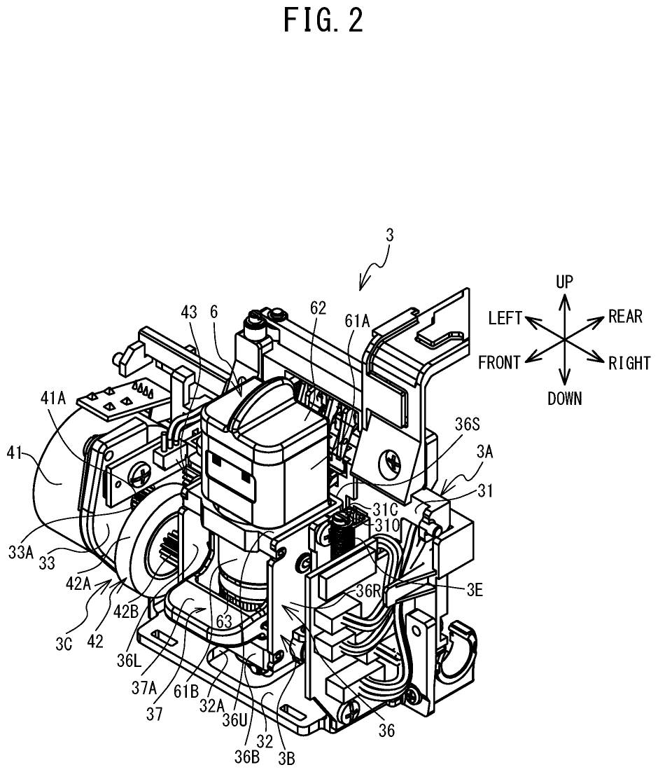

Using the conveyance mechanism 2C and the movement mechanism 2D, the cutting device 1 causes the carriage 3 to move in the main scanning direction and the sub-scanning direction relative to the object to be cut 9. At the same time, using a movement mechanism 3C (refer to FIG. 2) of the carriage 3 to be described later, the cutting device 1 causes the carriage 3 to move in the up-down direction relative to the object to be cut 9. In this way, the cutting device 1 cuts the object to be cut 9 into a desired shape using a cutting blade 72 of the holder 6 mounted to the carriage 3.

Carriage 3

As shown in FIG. 2 to FIG. 5, the carriage 3 is provided with a support body 3A, a mounting portion 3B, the movement mechanism 3C, a first spring 3D, a third spring 3E, and the like. Portions of the carriage 3 apart from a portion to which the holder 6 is mounted are covered by a cover 30 shown in FIG. 1. In FIG. 2 to FIG. 5, the cover 30 is omitted.

Support Body 3A

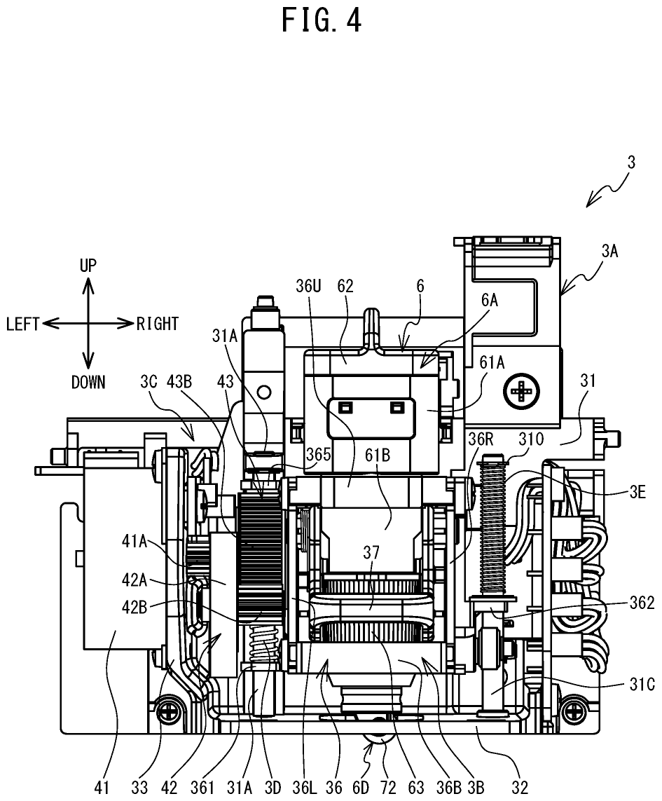

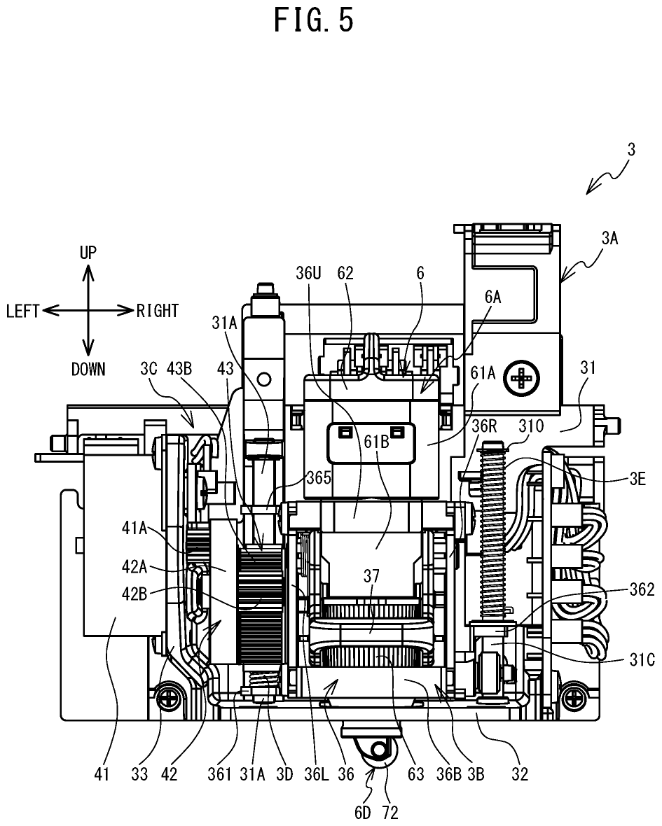

The support body 3A support the mounting portion 3B, the movement mechanism 3C, the first spring 3D (refer to FIG. 4 and FIG. 5), the third spring 3E, and the like. The support body 3A includes base portions 31, 32, and 33 that are each plate-shaped.

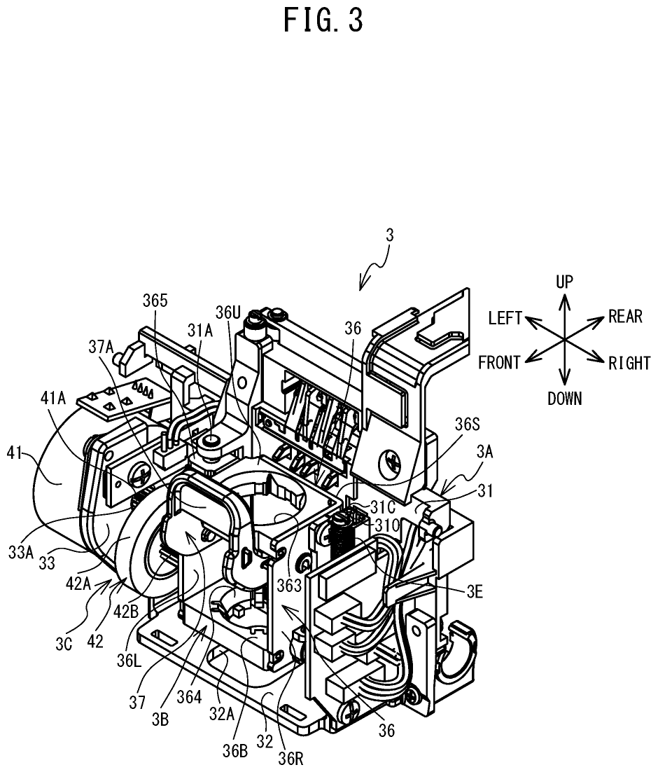

The base portion 31 is orthogonal to the front-rear direction. The base portion 31 is coupled to the guide rail 26 (refer to FIG. 1) at a rear surface thereof. The base portion 31 is supported by the guide rail 26 such that the base portion 31 can move in the left-right direction. As shown in FIG. 3, support shafts 31A and 31C are provided at positions separated from the base portion 31 to the front thereof. The support shafts 31A and 31C each have a circular cylindrical shape, and extend in the up-down direction. As shown in FIG. 4 and FIG. 5, the support shaft 31A is provided in the vicinity of the left end portion of the base portion 31. The first spring 3D (to be described later) is wound around the support shaft 31A. The support shaft 31A supports a rack gear 43 to be described later, such that the rack gear 43 can move in the up-down direction. The support shaft 31C is provided in the vicinity of the right end portion of the base portion 31. The third spring 3E (to be described later) is wound around the support shaft 31C.

As shown in FIG. 2 and FIG. 3, the base portion 32 is orthogonal to the up-down direction, and extends to the front from the lower end portion of the base portion 31. A through hole 32A is provided in the base portion 32 so as to penetrate the base portion 32 in the up-down direction. The base portion 33 is orthogonal to the left-right direction, and extends to the front from a position further to the left than the support shaft 31A of the base portion 31. A portion of the movement mechanism 3C to be described later is supported by the base portion 33.

Mounting Portion 3B

The mounting portion 3B is disposed to the front of the base portion 31, above the base portion 32, to the left of the support shaft 31C, and to the right of the support shaft 31A. The holder 6 (refer to FIG. 2) is mounted to the mounting portion 3B. The mounting portion 3B includes a holding body 36 and a lever 37. The holding body 36 holds the holder 6 in the state in which the holder 6 is mounted to the mounting portion 3B. The lever 37 fixes the holder 6 in the state of being held by the holding body 36, such that the holder 6 cannot be removed.

As shown in FIG. 3, the holding body 36 includes side plate portions 36S, 36R, and 36L, an upper plate portion 36U, and a bottom plate portion 36B. The side plate portion 36S is disposed to the front of the base portion 31 of the support body 3A, and is orthogonal to the front-rear direction. The side plate portion 36S is coupled to the base portion 31 such that the side plate portion 36S can move in the up-down direction. In this way, the mounting portion 3B is supported such that the mounting portion 3B can move in the up-down direction with respect to the support body 3A. The side plate portion 36R extends toward the front from the right end portion of the side plate portion 36S. The side plate portion 36L extends toward the front from the left end portion of the side plate portion 36S. The side plate portions 36R and 36L are each orthogonal to the left-right direction. The upper plate portion 36U is provided on the upper end portions of each of the side plate portions 36S, 36R, and 36L. The bottom plate portion 36B is provided on the lower end portions of each of the side plate portions 36S, 36R, and 36L. The upper plate portion 36U and the bottom plate portion 36B are each orthogonal to the up-down direction. The front end portion of the holding body 36 is open.

A circular through hole 363 is formed in the upper plate portion 36U so as to penetrate the upper plate portion 36U in the up-down direction. A circular through hole 364 is formed in the bottom plate portion 36B so as to penetrate the bottom plate portion 36B in the up-down direction. As shown in FIG. 2, in a state in which the holder 6 is held by the holding body 36, the holder 6 is inserted through the through holes 363 and 364. In this state, the upper end portion of the holder 6 protrudes further upward than the through hole 363, and the lower end portion of the holder 6 protrudes further downward than the through hole 364.

As shown in FIG. 4 and FIG. 5, a movable plate portion 361 is provided at the lower end portion of the side plate portion 36L, and a movable plate portion 365 is provided at the upper end portion of the side plate portion 36L. The movable plate portions 361 and 365 extend to the left from the left surface of the side plate portion 36L, and are orthogonal to the up-down direction. Through holes are formed in the movable plate portions 361 and 365 so as to penetrate the movable plate portions 361 and 365 in the up-down direction. The support shaft 31A of the support body 3A is inserted into the through holes of the movable plate portions 361 and 365. A movable plate portion 362 is provided on the side plate portion 36R. The movable plate portion 362 extends to the right from the right surface of the side plate portion 36R, and is orthogonal to the up-down direction. A through hole is formed in the movable plate portion 362 so as to penetrate the movable plate portion 362 in the up-down direction. The support shaft 31C of the support body 3A is inserted into the through hole of the movable plate portion 362.

As shown in FIG. 2 and FIG. 3, the lever 37 is rotatably supported by the side plate portions 36R and 36L of the holding body 36. The lever 37 includes a plate-shaped grip portion 37A that is long in the left-right direction. As shown in FIG. 2, in a state in which the lever 37 has rotated in a direction in which the grip portion 37A moves downward, the holder 6 that is held by the holding body 36 is fixed. In this state, the holder 6 cannot be removed from the holding body 36. On the other hand, as shown in FIG. 3, in a state in which the lever 37 has rotated in a direction in which the grip portion 37A moves upward, the state of the holder 6 being fixed to the holding body 36 is released. Thus, in this state, the holder 6 can be removed from the holding body 36.

Movement Mechanism 3C

The movement mechanism 3C moves the mounting portion 3B in the up-down direction with respect to the support body 3A. Note that as a result of the mounting portion 3B moving downward, the mounting portion 3B moves closer to the object to be cut 9 placed on the platen 2B. On the other hand, as a result of the mounting portion 3B moving upward, the mounting portion 3B moves away from the object to be cut 9 placed on the platen 2B.

As shown in FIG. 2 to FIG. 5, the movement mechanism 3C includes a Z-axis motor 41, a gear unit 42, the rack gear 43, and the like. The Z-axis motor 41 is disposed to the left of the base portion 33 of the support body 3A, and is fixed to the support body 3A by the base portion 33. A rotation shaft of the Z-axis motor 41 extends in the rightward direction, and is inserted to the right into a through hole 33A formed in the base portion 33 (refer to FIG. 2 and FIG. 3). A gear 41A is provided on the rotation shaft of the Z-axis motor 41. The gear 41A protrudes further to the right than the base portion 33.

The gear unit 42 includes an internal gear 42A and a pinion gear 42B. The internal gear 42A has a circular plate shape, and is orthogonal to the left-right direction. A circular recessed portion, which is recessed to the right, is formed in the left side of the internal gear 42A. Teeth are formed on the inner side surface of the recessed portion. The pinion gear 42B is provided on the right surface of the internal gear 42A. The diameter of the pinion gear 42B is smaller than the diameter of the internal gear 42A. Positions of rotational centers of each of the internal gear 42A and the pinion gear 42B are aligned with each other, and extend in the left-right direction. Hereinafter, the rotational centers of each of the internal gear 42A and the pinion gear 42B are referred to as a “rotational center of the gear unit 42.” The internal gear 42A and the pinion gear 42B rotate integrally with each other.

As shown in FIG. 4 and FIG. 5, the gear unit 42 is provided to the right of the base portion 33 of the support body 3A, and is rotatably fixed to the base portion 33. The rotational center of the gear unit 42 is positioned below the rotational shaft of the Z-axis motor 41. The gear 41A provided on the rotational shaft of the Z-axis motor 41 is inserted, from the left, into the recessed portion formed in the left surface of the internal gear 42A. The gear 41A meshes with the teeth provided on the inner side surface of the internal gear 42A. The drive force of the Z-axis motor 41 generated in accordance with the Z-axis motor 41 being driven and the gear 41A rotating is transmitted to the gear unit 42 via the gear 41A and the internal gear 42A. In this way, the pinion gear 42B of the gear unit 42 also rotates.

The rack gear 43 is provided to the rear of the pinion gear 42B. The rack gear 43 includes a rectangular column-shaped base that extends in the up-down direction. The rack gear 43 includes gear teeth 43B on the front surface of the base. The rack gear 43 further includes a through hole in the base that penetrates the base in the up-down direction. The support shaft 31A fixed to the support body 3A is inserted into that through hole. The rack gear 43 moves up and down along the support shaft 31A. The gear teeth 43B of the rack gear 43 mesh with the pinion gear 42B. The rack gear 43 moves in the up-down direction in accordance with the rotation of the pinion gear 42B.

First Spring 3D

The first spring 3D is positioned below the rack gear 43. The first spring 3D is a compression coil spring, and is wound in the vicinity of the lower end portion of the support shaft 31A. The upper end portion of the first spring 3D is coupled to the lower end portion of the rack gear 43. The lower end portion of the first spring 3D is coupled to the movable plate portion 361 of the mounting portion 3B. The first spring 3D is interposed between the rack gear 43 and the movable plate portion 361 of the mounting portion 3B, and urges the rack gear 43 upward. In this way, the upper end portion of the rack gear 43 comes into contact, from below, with the movable plate portion 365 of the mounting portion 3B, and presses the movable plate portion 365 upward. A spring constant of the first spring 3D is denoted by a “first spring constant K1.”

When the Z-axis motor 41 of the movement mechanism 3C is driven, the first spring 3D moves the mounting portion 3B in the up-down direction in conjunction with the movement in the up-down direction of the rack gear 43. Further, when the first spring 3D is compressed in accordance with the downward movement of the rack gear 43, the first spring 3D applies a downward pressure on the mounting portion 3B.

Third Spring 3E

The third spring 3E is a compression coil spring, and is wound around the support shaft 31C. A fixing washer 310 is fixed to the upper end portion of the support shaft 31C. The upper end portion of the third spring 3E is in contact, from below, with the fixing washer 310. The lower end portion of the third spring 3E is coupled to the movable plate portion 362 of the mounting portion 3B. The third spring 3E is interposed between the fixing washer 310 and the movable plate portion 362 of the mounting portion 3B, and applies a downward pressure to the mounting portion 3B. A spring constant of the third spring 3E is denoted by a “third spring constant K3.” The third spring constant K3 is smaller than the first spring constant K1 of the first spring 3D. Regardless of a driving state of the Z-axis motor 41 of the movement mechanism 3C, the third spring 3E constantly applies the downward pressure to the mounting portion 3B.

Holder 6

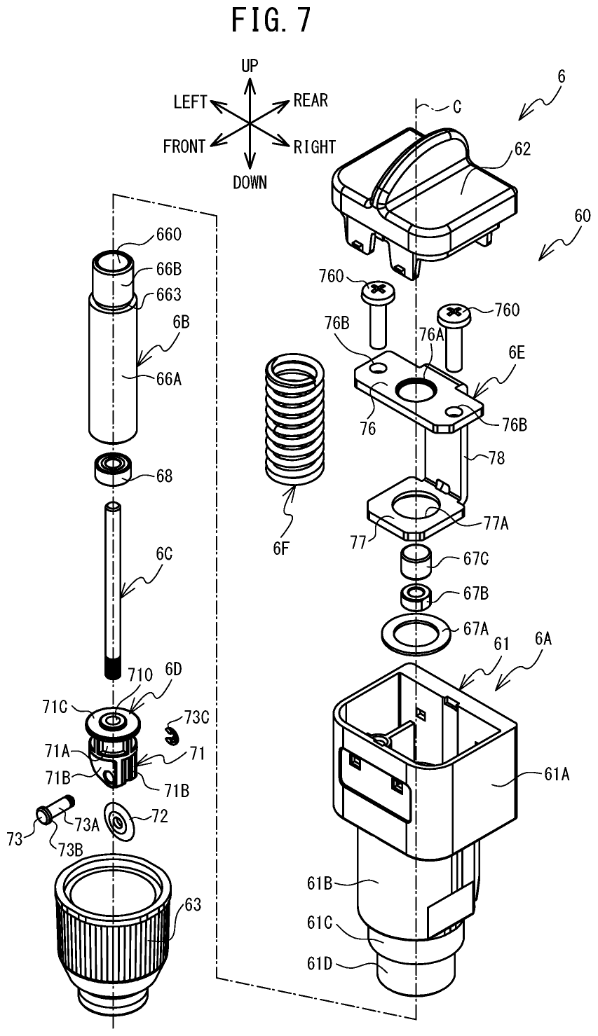

The holder 6 will be explained with reference to FIG. 6 to FIG. 9. The holder 6 is used in a state of being mounted to the mounting portion 3B, and cuts the object to be cut 9 using the cutting blade 72. As shown in FIG. 7, the holder 6 includes a housing 6A, a support body 6B, a rotation shaft 6C, a cutting body 6D, an intermediate body 6E, and a second spring 6F. The housing 6A and the intermediate body 6E are referred to as a “holding body 60.”

Housing 6A

The housing 6A is made of resin, and houses the support body 6B, the rotation shaft 6C, the cutting body 6D, the intermediate body 6E, and the second spring 6F, which are to be described later. As shown in FIG. 6 and FIG. 7, the housing 6A includes a main body portion 61, a lid portion 62, and a screw cap 63.

As shown in FIG. 7, the main body portion 61 includes a rectangular cylindrical portion 61A, and circular cylindrical portions 61B, 61C, and 61D, each of which extend in the up-down direction. The rectangular cylindrical portion 61A has a rectangular shape of which a cross section that is orthogonal to the up-down direction is long in the left-right direction. The lid portion 62 closes the opening of the upper end portion of the rectangular cylindrical portion 61A. The circular cylindrical portions 61B, 61C, and 61D are provided below the rectangular cylindrical portion 61A. The circular cylindrical portions 61B, 61C, and 61D are aligned downward in this order. The diameter of the circular cylindrical portion 61B is shorter than the length, in the left-right direction, of the rectangular cylindrical portion 61A. The diameter of the circular cylindrical portion 61B is substantially the same as the diameter of the through hole 363 (refer to FIG. 3) provided in the upper plate portion 36U of the mounting portion 3B. The diameter of the circular cylindrical portion 61C is smaller than the diameter of the circular cylindrical portion 61B. A plurality of screw threads, with which the screw cap 63 to be described later is fitted, are formed on the side surface of the circular cylindrical portion 61C. The diameter of the circular cylindrical portion 61D is smaller than the diameter of the circular cylindrical portion 61C. Hereinafter, a straight line extending in the up-down direction along the centers of the circular cylindrical portions 61B, 61C, and 61D will be referred to as a “center line C.”

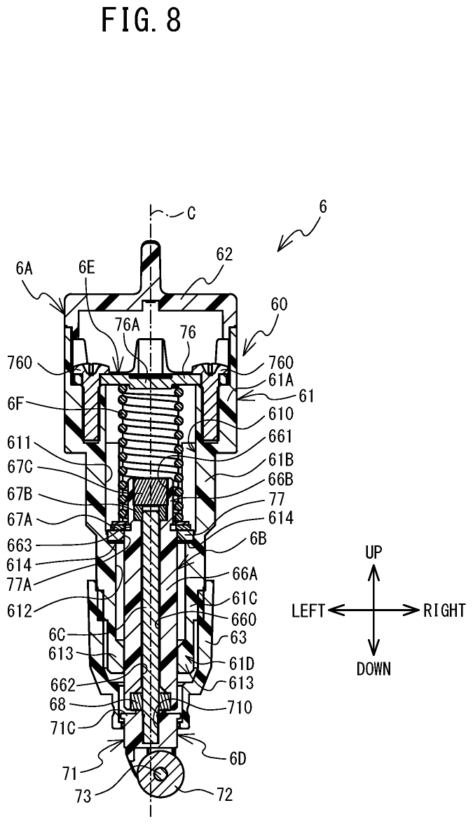

As shown in FIG. 8, a through hole 610 that penetrates the interiors of the circular cylindrical portions 61B, 61C, and 61D in the up-down direction includes inner diameter portions 611 and 612 having differing inner diameters. The inner diameter portions 611 and 612 are aligned downward in that order. The inner diameter of the inner diameter portion 612 is smaller than the inner diameter of the inner diameter portion 611. The inner diameter portion 611 is disposed on the inside of the circular cylindrical portion 61B. The inner diameter portion 612 is disposed on the inside of the circular cylindrical portions 61C and 61D. In the vicinity of the lower end portion of the inner diameter portion 612, a portion that protrudes toward the center line C (hereinafter referred to as a “first support portion 613”) is provided.

As shown in FIG. 6 and FIG. 7, the screw cap 63 is fixed by being screwed onto the circular cylindrical portions 61C and 61D of the main body portion 61. The screw cap 63 has a circular cylindrical shape, and an opening is provided in both ends thereof in the up-down direction. A plurality of screw threads provided on the inner surface of the screw cap 63 engage with the plurality of screw threads provided on the side surface of the circular cylindrical portion 61C. The screw cap 63 is removed from the main body portion 61 when replacing the support body 6B, the rotation shaft 6C, and the cutting body 6D to be described later. The outer diameter of the screw cap 63 is substantially the same as the diameter of the through hole 364 (refer to FIG. 3) provided in the bottom plate portion 36B of the mounting portion 3B.

In the state in which the holder 6 is mounted to the mounting portion 3B, the housing 6A is held by the mounting portion 3B. As shown in FIG. 2, the circular cylindrical portion 61B of the main body portion 61 of the housing 6A fits into the through hole 363 (refer to FIG. 3) of the upper plate portion 36U of the mounting portion 3B. The screw cap 63 of the housing 6A fits into the through hole 364 (refer to FIG. 3) of the bottom plate portion 36B of the mounting portion 3B. Further, the rectangular cylindrical portion 61A of the main body portion 61 of the housing 6A is disposed above the upper plate portion 36U of the mounting portion 3B. As shown in FIG. 4, the lower end portion of the screw cap 63 of the housing 6A protrudes further downward than the lower end of the bottom plate portion 36B.

Support Body 6B, Rotation Shaft 6C

As shown in FIG. 7, the support body 6B supports the cutting body 6D via the rotation shaft 6C to be described later. The support body 6B has a circular cylindrical shape. The support body 6B includes an enlarged diameter portion 66A and an insertion portion 66B, which have mutually different outer diameters. The insertion portion 66B is positioned above the enlarged diameter portion 66A. As shown in FIG. 8, a through hole 660 penetrates the support body 6B in the up-down direction. The inner diameter of the through hole 660 is different at the enlarged diameter portion 66A and at the insertion portion 66B. The inner diameter of a through hole 661 of the insertion portion 66B is larger than the inner diameter of a through hole 662 of the enlarged diameter portion 66A.

As shown in FIG. 7, a recessed portion 663 that is recessed toward the center line C is provided in the side surface of the insertion portion 66B, at a portion in the vicinity of the enlarged diameter portion 66A. The diameter of the bottom surface of the recessed portion 663 is smaller than the outer diameter of the insertion portion 66B. As shown in FIG. 8, a fixed washer 67A is engaged with the recessed portion 663. The outer diameter of the fixed washer 67A is larger than the outer diameter of the enlarged diameter portion 66A.

The rotation shaft 6C is inserted into the through hole 662 of the enlarged diameter portion 66A. The rotation shaft 6C is a magnetic body, and more specifically, is made of metal. As shown in FIG. 7, the rotation shaft 6C has a circular cylindrical shape, and extends in the up-down direction. As shown in FIG. 8, the lower end portion of the rotation shaft 6C protrudes further downward than the lower end portion of the support body 6B. The cutting body 6D, which will be described later, is coupled to the lower end portion of the rotation shaft 6C. The diameter of the rotation shaft 6C is substantially the same as the inner diameter of the through hole 662 of the enlarged diameter portion 66A of the support body 6B. The rotation shaft 6C fits closely with the through hole 662 of the support body 6B, and is rotatably supported by the support body 6B. A bearing 68 is held at the lower end portion of the through hole 662. The bearing 68 alleviates friction when the rotation shaft 6C rotates with respect to the support body 6B, and causes the rotation shaft 6C to rotate smoothly.

A spacer 67B and a magnet 67C are disposed in the through hole 661 of the insertion portion 66B of the support body 6B. The spacer 67B is positioned in the vicinity of the lower end portion of the through hole 661. A portion of the upper end portion of the rotation shaft 6C is inserted through a through hole of the spacer 67B. The magnet 67C is positioned above the spacer 67B, in the through hole 661. The magnet 67C is adjacent to the upper side of the rotation shaft 6C. A gap is formed between the lower end portion of the magnet 67C and the upper end portion of the rotation shaft 6C. The rotation shaft 6C is attracted upward by the magnetic force of the magnet 67C.

The support body 6B is inserted into the through hole 610 of the housing 6A. In this state, the first support portion 613 provided in the inner diameter portion 612 of the housing 6A is in contact with the vicinity of the lower end portion of the support body 6B. Using the first support portion 613, the housing 6A supports the support body 6B such that the support body 6B can move in the up-down direction. The lower end portion of the support body 6B protrudes further downward than the lower end portion of the circular cylindrical portion 61D of the housing 6A, and is disposed on the inside of the screw cap 63.

Cutting Body 6D

As shown in FIG. 6 to FIG. 8, the cutting body 6D is provided on the lower end portion of the housing 6A. The cutting body 6D includes a rotation support portion 71, the cutting blade 72, a support shaft 73, and the like.

As shown in FIG. 7, the cutting blade 72 has a circular plate shape, and cuts the object to be cut 9 using a peripheral end portion thereof. A through hole is formed in the center of the cutting blade 72. The rotation support portion 71 includes a base portion 71A, a pair of support portions 71B, and a protruding portion 71C. A recessed portion 710 that is recessed downward is formed in the upper end portion of the base portion 71A. As shown in FIG. 8, the lower end portion of the rotation shaft 6C is inserted into the recessed portion 710 from above and engages with the recessed portion 710. In this state, the cutting body 6D is coupled to the rotation shaft 6C. As shown in FIG. 7, the pair of support portions 71B are separated from each other in the horizontal direction, and extend downward from the lower end portion of the base portion 71A. The pair of support portions 71B are positioned on both sides, in the horizontal direction, of the cutting blade 72. A through hole that extends in the horizontal direction is formed in the leading end portion of each of the pair of support portions 71B. The protruding portion 71C has a circular plate shape, and protrudes in the horizontal direction toward the opposite side from the center line C, from the upper end portion of the base portion 71A.

The support shaft 73 includes a shaft portion 73A, a head portion 73B, and a retaining ring 73C. The shaft portion 73A has a circular columnar shape, and extends in the horizontal direction. The head portion 73B is provided on one end portion of the shaft portion 73A, and protrudes outward. The shaft portion 73A is inserted into the through holes of the pair of support portions 71B of the rotation support portion 71, and into the through hole of the cutting blade 72. In this way, the cutting blade 72 is rotatably supported with respect to the rotation support portion 71. The retaining ring 73C engages with the other end of the shaft portion 73A, and stops disengagement of the shaft portion 73A.

As shown in FIG. 8, the protruding portion 71C of the cutting body 6D is clamped, from above and below, by the circular cylindrical portion 61D of the housing 6A and the lower end portion of the screw cap 63. In this way, the cutting body 6D is rotatably supported with respect to the housing 6A, and cannot be removed from the housing 6A. The cutting body 6D rotate with respect to the housing 6A in accordance with a direction (a cutting direction) of the relative movement of the cutting blade 72 and the object to be cut 9 when cutting the object to be cut 9.

Intermediate Body 6E

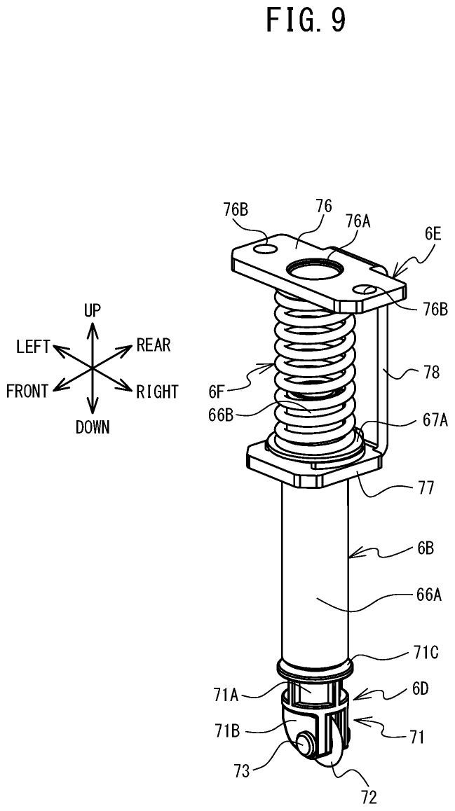

The intermediate body 6E is disposed inside the housing 6A, and supports the support body 6B, and the second spring 6F to be described later. The intermediate body 6E is made of metal. As shown in FIG. 7 and FIG. 9, the intermediate body 6E includes a contact portion 76, a second support portion 77, and a bridge portion 78.

As shown in FIG. 7, the contact portion 76 has a rectangular plate shape that is long in the left-right direction, and is orthogonal to the up-down direction. A circular concave portion 76A that protrudes downward is formed on the bottom surface of the contact portion 76 (refer to FIG. 8). A pair of through holes 76B are formed on the left and right sides of the concave portion 76A, in the contact portion 76. The pair of through holes 76B each have a circular shape, and penetrate the contact portion 76 in the up-down direction. The second support portion 77 has a substantially square plate shape, and is orthogonal to the up-down direction. The second support portion 77 is separated downward from the contact portion 76. A through hole 77A is formed in the center of the second support portion 77. The through hole 77A is circular, and penetrates the second support portion 77 in the up-down direction. The diameter of the through hole 77A is substantially the same as the outer diameter of the enlarged diameter portion 66A of the support body 6B.

The bridge portion 78 extends in the up-down direction over a space between the contact portion 76 and the second support portion 77. The bridge portion 78 has a plate shape and is orthogonal to the front-rear direction. The bridge portion 78 bridges the space between the contact portion 76 and the second support portion 77, and holds the contact portion 76 and the second support portion 77 in a state of being separated from each other in the up-down direction.

As shown in FIG. 8, two screws 760 are inserted, from above, through the pair of through holes 76B (refer to FIG. 7) of the contact portion 76 of the intermediate body 6E, and are screwed into screw holes inside the housing 6A. In this way, the intermediate body 6E is fixed inside the housing 6A. In this state, the intermediate body 6E is positioned above the first support portion 613 of the housing 6A. Further, the second support portion 77 of the intermediate body 6E is in contact, from above, with a step 614 formed at a boundary section between the inner diameter portion 611 and the inner diameter portion 612, of the through hole 610 of the housing 6A.

As shown in FIG. 9, the support body 6B is inserted, from below, into the through hole 77A (refer to FIG. 7) of the second support portion 77 of the intermediate body 6E. The fixing washer 67A that is engaged with the insertion portion 66B of the support body 6B, and the recessed portion 663 of the support body 6B (refer to FIG. 7 and FIG. 8) is positioned above the second support portion 77. As shown in FIG. 8, the through hole 77A of the second support portion 77 is in contact with a portion in the vicinity of the upper end portion of the enlarged diameter portion 66A of the support body 6B. Using the second support portion 77, the intermediate body 6E supports the support body 6B such that the support body 6B can move in the up-down direction. Note that, as already described above, the support body 6B is also supported by the first support portion 613 of the housing 6A such that the support body 6B can move in the up-down direction. In other words, the support body 6B is supported so as to be able to move in the up-down direction by the housing 6A and the intermediate body 6E that configure the holding body 60, more specifically, by the first support portion 613 of the housing 6A and the second support portion 77 of the intermediate body 6E that are separated from each other in the up-down direction.

Second Spring 6F

As shown in FIG. 7, the second spring 6F is a compression coil spring, and is extendable and contractable in the up-down direction. The second spring 6F is provided in order to apply downward pressure to the cutting blade 72 of the cutting body 6D.

As shown in FIG. 8 and FIG. 9, the second spring 6F is interposed between the contact portion 76 and the second support portion 77 of the intermediate body 6E. The upper end portion of the second spring 6F is in contact, from below, with the bottom surface of the contact portion 76 of the intermediate body 6E. The concave portion 76A of the contact portion 76 is positioned on the inside of the upper end portion of the second spring 6F. The concave portion 76A suppresses the position of the upper end portion of the second spring 6F from becoming displaced with respect to the contact portion 76. The insertion portion 66B of the support body 6B is inserted inside of the vicinity of the lower end portion of the second spring 6F. The lower end portion of the second spring 6F is in contact, from above, with the upper surface of the fixing washer 67A that is engaged with the recessed portion 663 of the support body 6B. In other words, the lower end portion of the second spring 6F is coupled to the support body 6B at a position above the first support portion 613 of the housing 6A and the second support portion 77 of the intermediate body 6E.

A spring contact of the second spring 6F is referred to as a “second spring constant K2.” The second spring constant K2 is greater than the first spring constant K1 of the first spring 3D (refer to FIG. 4 and FIG. 5), and is greater than the third spring constant K3 of the third spring 3E (refer to FIG. 4 and FIG. 5). The length in an extension/contraction direction, when the third spring 3E is compressed to a maximum extent and the helical wires are in close contact with each other, is referred to as a close contact length. The length, in the up-down direction, of the insertion portion 66B of the support body 6B is shorter than the close contact length of the third spring 3E.

Operation Example

The holder 6 is mounted to the mounting portion 3B, and the mounting portion 3B is disposed at a highest position, of a movable range of the mounting portion 3B in the up-down direction. Further, the holding portion 90 holding the object to be cut 9 is placed on the platen 2B. The position, in the up-down direction, of the mounting portion 3B that is disposed at the highest position is referred to as a “stand-by position.”

FIG. 4 shows the mounting portion 3B disposed at the stand-by position, and the holder 6 mounted to the mounting portion 3B. The lower end portion of the housing 6A of the holder 6 mounted to the mounting portion 3B is positioned above the base portion 32 of the support body 3A that supports the mounting portion 3B. Further, the cutting body 6D provided at the lower end portion of the housing 6A is inserted through the through hole 32A (refer to FIG. 2) of the base portion 32. The cutting blade 72 of the cutting body 6D protrudes slightly further downward than the base portion 32. Further, the cutting blade 72 is separated upward from the object to be cut 9 placed, via the holding portion 90, on the platen 2B of the cutting device 1.

In the state in which the mounting portion 3B is disposed at the stand-by position, the third spring 3E is in a state of being compressed between the fixing washer 310 at the upper end portion thereof and the movable plate portion 362 at the lower end portion thereof. Thus, the third spring 3E applies the downward pressure to the movable plate portion 362 of the mounting portion 3B. The mounting portion 3B receives the downward force from the third spring 3E via the movable plate portion 362. On the other hand, the rotation of the pinion gear 42B that meshes with the rack gear 43 is suppressed by the rotation load of the Z-axis motor 41, and thus, the movement of the rack gear 43 in the up-down direction is suppressed. As a result, the downward movement of the movable plate portion 365 of the mounting portion 3B, which is in contact with the upper end portion of the rack gear 43, is also suppressed. Thus, even in the state of receiving the downward force from the third spring 3E, the mounting portion 3B does not move downward and is stationary.

When cutting the object to be cut 9 using the cutting blade 72, a control portion (not shown in the drawings) of the cutting device 1 drives the Z-axis motor 41, and rotates the gear 41A. In accordance with the rotation of the gear 41A, the internal gear 42A and the pinion gear 42B of the gear unit 42 rotate integrally. In this way, the rack gear 43 that meshes with the pinion gear 42B moves downward. In accordance with the downward movement of the rack gear 43, the first spring 3D coupled to the lower end portion of the rack gear 43 also moves downward and does not contract. Note that the mounting portion 3B is in contact with the upper end portion of the rack gear 43 via the movable plate portion 365, and is coupled to the lower end portion of the first spring 3D via the movable plate portion 361. Thus, the mounting portion 3B moves downward from the stand-by position in accordance with the movement of the rack gear 43.

In accordance with the downward movement of the mounting portion 3B, the holder 6 also moves downward. The cutting blade 72 of the holder 6 gradually approaches the object to be cut 9 positioned below the cutting blade 72, and comes into contact with the object to be cut 9. At this time, since the cutting blade 72 is in contact with the object to be cut 9, an upward pressure acts on the mounting portion 3B via the holder 6. By continuously driving the Z-axis motor 41, the rack gear 43 moves further downward. At this time, the third spring 3E that has the spring constant that is smaller than that of the first spring 3D and the second spring 6F (refer to FIG. 7) of the holder 6 applies a downward force to the mounting portion 3B via the movable plate portion 362. Due to this force, the cutting blade 72 of the holder 6 mounted to the mounting portion 3B attempts to penetrate and cut the object to be cut 9.

There is a case in which the object to be cut 9 is hard, and it is not possible to cause the cutting blade 72 to penetrate the object to be cut 9 using the force applied by the third spring 3E. At this time, the downward movement of the mounting portion 3B is suppressed by the upward force received by the mounting portion 3B from the object to be cut 9 via the holder 6. When the pinion gear 42B rotates further in this state, the rack gear 43 moves further downward. In this way, the upper end portion of the rack gear 43 separates from the movable plate portion 365, and the rack gear 43 moves downward while compressing the first spring 3D having the spring constant that is smaller than that of the second spring 6F of the holder 6. The first spring 3D applies the downward force that is stronger than the third spring 3E, to the mounting portion 3B via the movable plate portion 361. As a result of this force, the cutting blade 72 of the holder 6 mounted to the mounting portion 3B moves downward and penetrates the object to be cut 9, and attempts to cut the object to be cut 9.

There is a case when the object to be cut 9 is even harder, and it is not possible to cause the cutting blade 72 to penetrate the object to be cut 9 using the force applied by the first spring 3D. The downward movement of the mounting portion 3B is suppressed. As a result of the pinion gear 42B rotating and the rack gear 43 moving further downward, the first spring 3D is further compressed, as shown in FIG. 5. The downward force received by the mounting portion 3B from the first spring 3D increases. At this time, the second spring 6F of the holder 6 having the spring constant that is greater than that of the first spring 3D is compressed between the contact portion 76 and the fixed washer 67A engaged with the support body 6B, by the downward force received from the first spring 3D. The second spring 6F applies a downward force that is stronger than that of the first spring 3D and the third spring 3E, to the support body 6B via the fixed washer 67A. As a result of this force, the cutting blade 72 of the cutting body 6D that is supported by the support body 6B via the rotation shaft 6C penetrates and cuts the object to be cut 9.

Operations and Effects of Present Embodiment

The second spring 6F is provided on the holder 6 that is detachably attached to the mounting portion 3B. In comparison to a case in which the holder 6 does not include the second spring 6F, the cutting device 1 can increase the pressure (a cutter pressure) applied to the cutting blade 72 via the mounting portion 3B when cutting the object to be cut 9. Thus, even when the large cutter pressure is required when cutting the object to be cut 9, the cutting device 1 can apply the appropriate cutter pressure to the cutting blade 72 and can cut the object to be cut 9.

The holder 6 includes the second spring 6F having the larger spring constant (the second spring constant K2). Thus, even when the large cutter pressure is required when cutting the object to be cut 9, the cutting device 1 can appropriately cut the object to be cut 9 using the second spring 6F.

The cutting device 1 further includes the third spring 3E. The third spring 3E can apply the pressure to the mounting portion 3B in a state before the pressure is applied by the first spring 3D in the course of the downward movement of the mounting portion 3B. Thus, the cutting device 1 can apply the pressure to the cutting blade 72 via the mounting portion 3B over a wider movement range in the course of the downward movement of the mounting portion 3B.

In the holder 6, the rotation shaft 6C coupled to the cutting body 6D is attracted upward by the magnet 67C. Thus, the holder 6 can suppress the cutting body 6D from becoming disengaged from the support body 6B in a state in which the screw cap 63 is removed, and an operation by the user to replace the cutting body 6D can be simplified. When cutting the object to be cut 9, the holder 6 can allow the cutting blade 72 of the cutting body 6D to rotate in response to the cutting direction, using the magnet 67C.

The length in the up-down direction of the insertion portion 66B of the support body 6B is shorter than the close contact length of the second spring 6F. Thus, even when the second spring 6F is compressed to the maximum extent, the upper end portion of the insertion portion 66B is not in contact with the contact portion 76 of the intermediate body 6E. As a result, even when the second spring 6F is compressed to the maximum extent, the holder 6 can apply the pressure to the cutting blade 72 via the support body 6B.

The holder 6 supports the support body 6B using the housing 6A and the intermediate body 6E that configure the holding body 60, more specifically, using the first support portion 613 of the housing 6A, and the second support portion 77 of the intermediate body 6E. The first support portion 613 and the second support portion 77 are separated from each other in the up-down direction that is the movement direction of the support body 6B. Thus, the holder 6 can support the support body 6B in a stable manner and cause the support body 6B to move smoothly in the up-down direction.

When the second spring 6F has come into contact with the contact portion 76 of the intermediate body 6E, a load that accords with the pressure is likely to act on the contact portion 76. Further, since the second support portion 77 of the intermediate body 6E is in contact with the support body 6B, a load is likely to act on the second support portion 77. In contrast to this, the contact portion 76 and the second support portion 77 are included in the intermediate body 6E, and are separate members from the housing 6A. In this way, the holder 6 can increase the durability of the housing 6A. Further, as the intermediate body 6E that is susceptible to the load is made of metal, the strength thereof can be increased, and the holder 6 can thus suppress degradation over time.

### MODIFIED EXAMPLES

The present disclosure is not limited to the above-described embodiment, and various modifications are possible. In the above-described embodiment, the object to be cut 9 is placed on the platen 2B in a state of being held by the holding portion 90, and is cut by the cutting device 1. The object to be cut 9 may be simply placed on the platen 2B and cut by the cutting device 1. The holder 6 may be fixed to the mounting portion 3B and may be configured so as not to be removable. Each of the first spring 3D, the second spring 6F, and the third spring 3E may include a plurality of compression coil springs. In this case, the spring constants of the first spring 3D, the second spring 6F, and the third spring 3E may be an aggregate of the spring constants of the plurality of springs.

A magnitude relationship between the first spring constant K1 of the first spring 3D, the second spring constant K2 of the second spring 6F, and the third spring constant K3 of the third spring 3E (K2>K1>K3) is not limited to that of the above-described embodiment. For example, the first spring constant K1 may be larger than the second spring constant K2. The third spring constant K3 may be larger than the first spring constant K1 and the second spring constant K2. The first spring constant K1, the second spring constant K2, and the third spring constant K3 may be the same as each other. The first spring 3D and the third spring 3E is not limited to being the compression coil spring and may be a spiral spring, for example. The movement mechanism 3C may apply the downward force to the mounting portion 3B by causing the spiral spring to rotate by driving the Z-axis motor 41. The cutting device 1 need not necessarily include the third spring 3E, and may include only the first spring 3D.

The cutting blade 72 of the holder 6 is not limited to the circular plate shape, and may have a rectangular plate shape with a pointed leading end. The holder 6 need not necessarily be provided with the rotation shaft 6C. In this case, the magnet 67C may directly attract the cutting body 6D upward.

The second spring 6F is not limited to being the coil spring, and may be a disk spring, a ring spring, a plate spring, or the like. In place of the concave portion 76A, a through hole may be formed in the contact portion 76 of the intermediate body 6E. The diameter of the through hole may be larger than the diameter of the insertion portion 66B of the support body 6B. In this case, the length in the up-down direction of the insertion portion 66B of the support body 6B may be longer than the close contact length of the second spring 6F. Note that when the second spring 6F is compressed to the maximum extent, the insertion portion 66B of the support body 6B is inserted into the through hole formed in the contact portion 76. Thus, since it is possible to suppress the upper end portion of the insertion portion 66B from coming into contact with the contact portion 76 of the intermediate body 6E, even when the second spring 6F is compressed to the maximum extent, the holder 6 can apply the pressure to the cutting blade 72 via the support body 6B.

The inner diameter portion 612 of the housing 6A may be in contact with the support body 6B over an entire region in the up-down direction. In this case, the intermediate body 6E need not necessarily be provided with the second support portion 77, and need not necessarily support the support body 6B. The intermediate body 6E may be configured only by the contact portion 76. Furthermore, the holder 6 need not necessarily be provided with the intermediate body 6E. In this case, the upper end portion of the second spring 6F may directly be in contact with the housing 6A. The housing 6A is not limited to being made of resin, and may be configured by another material (metal or the like, for example). The intermediate body 6E is not limited to being made of metal and may be configured by another material (resin or the like, for example).

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A cutting device comprising:
a placement member on which an object to be cut is placed; and
a carriage configured to move in a first direction and a second direction relative to the object to be cut placed on the placement member, the second direction being opposite to the first direction, the carriage including
a mounting portion to which a holder holding a cutting blade that cuts the object to be cut is mountable,
a movement mechanism configured to move the mounting portion in a third direction causing the mounting portion to move closer to the object to be cut placed on the placement member, and a fourth direction causing the mounting portion to move away from the object to be cut placed on the placement member, the third direction and the fourth direction intersecting the first direction and the second direction, and
a first spring configured to apply a pressure to the mounting portion in the third direction, in accordance with a driving state of the movement mechanism;
wherein the holder includes a second spring configured to apply a pressure to the cutting blade in the third direction.

2. The cutting device according to claim 1, wherein
a spring constant of the second spring is larger than a spring constant of the first spring.

3. The cutting device according to claim 1, wherein
the carriage further includes a third spring configured to apply a pressure to the mounting portion in the third direction, irrespective of the movement of the mounting portion by the movement mechanism, and
a spring constant of the third spring is smaller than a spring constant of the first spring and a spring constant of the second spring.

4. A holder mountable on a mounting portion of a cutting device that includes a placement member on which an object to be cut is placed, and a carriage configured to move in a first direction and a second direction relative to the object to be cut placed on the placement member, the second direction being opposite to the first direction, the carriage including the mounting portion, a movement mechanism configured to move the mounting portion in a third direction causing the mounting portion to move closer to the object to be cut placed on the placement member, and a fourth direction causing the mounting portion to move away from the object to be cut placed on the placement member, the third direction and the fourth direction intersecting the first direction and the second direction, and a first spring configured to apply a pressure to the mounting portion in the third direction, in accordance with the movement of the mounting portion by the movement mechanism, the holder comprising:
a cutting blade configured to cut the object to be cut;
a support body configured to support the cutting blade;
a holding body configured to support the support body to be movable in a fifth direction and a sixth direction opposite to the fifth direction, the holding body being held by the mounting portion; and
a second spring configured to urge the support body in the fifth direction with respect to the holding body.

5. The holder according to claim 4, further comprising:
a rotation shaft coupled to the cutting blade and extending in the fifth direction and the sixth direction, the rotation shaft being formed of a magnetic body, wherein
the support body rotatably supports the rotation shaft, and
the support body includes a magnet that is positioned in the sixth direction with respect to the rotation shaft and attracts the rotation shaft.

6. The holder according to claim 4, wherein
the second spring is a coil spring configured to be contractable and extendable in an extension direction parallel to the fifth direction and the sixth direction,
an insertion portion that is a portion of the support body is inserted inside the coil spring, and
a length of the insertion portion in the extension direction is shorter than a close contact length of the second spring.

7. The holder according to claim 4, wherein
the holding body movably supports the support body, using a first support portion and a second support portion separated from each other in a direction parallel to the fifth direction and the sixth direction.

8. The holder according to claim 4, wherein
the second spring is a coil spring configured to be contractable and extendable in an extension direction parallel to the fifth direction and the sixth direction,
the holding body includes a housing, and an intermediate body configured to support the second spring and the support body inside the housing,
the housing includes a first support portion configured to support the support body at a position further to the fifth direction side than the intermediate body,
the intermediate body includes
a contact portion in contact with an end portion on the sixth direction side of the second spring,
a second support portion separated, to the fifth direction side, from the contact portion and configured to support the support body, and
a bridge portion extending between the contact portion and the second support portion, and
an end portion on the fifth direction side of the second spring is coupled to the support body at a position further to the sixth direction side than the first support portion.

9. The holder according to claim 8, wherein
the housing is made of resin, and the intermediate body is made of metal.

10. The holder according to claim 4, wherein
in a state in which the holding body is held by the mounting portion, the third direction and the fifth direction are aligned, and the fourth direction and the sixth direction are aligned.
